(19) United States
(12) Patent Application Publication
(10) Pub. No.: US 2009/0249035 A1
(43) Pub. Date: Oct. 1, 2009

(54) MULTI-CYCLE REGISTER FILE BYPASS

(75) Inventors: Harry Barowski, Boeblingen (DE); Tobias Gemmeke, Santa Clara, CA (US); Nicolas Maeding, Holzgerlingen (DE); Tim Niggemeier, Laatzen (DE)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 12/058,043

(22) Filed: Mar. 28, 2008

(51) Int. Cl. G06F 9/30

(52) U.S. Cl. 712/218; 712/E09.026

(57) ABSTRACT

A method of reducing latency in instruction processing in a system, includes calculating a result of a first execution unit, storing the result of the first execution unit in a register file, forwarding the result of the first execution unit, through the bypass unit, to a second execution unit, the second execution unit conducting an instruction dependent on the result, forwarding the result of the first execution unit, from the bypass unit, to a third execution unit, without accessing the register file, the third execution unit conducting an instruction dependent on the result, wherein the execution units can extract the result of the first execution unit through the bypass unit until the new result is calculated, wherein after the new result is calculated, the execution units can access the result of the first execution unit through the register file.

### BACKGROUND OF THE INVENTION

1. Field of the Invention

The present invention generally relates to a method and apparatus for instruction processing, and more particularly to a method and apparatus for register renaming in an out-of-order (OoO) processor.

2. Description of the Related Art

One major focal point with current microprocessors is power reduction. There are various approaches to reduce the numerous power sources on a microprocessor.

Dynamic power consumption of register files, however, is a major contributor to the dynamic power of an arithmetic unit on a microprocessor. More precisely, it is the dynamic power consumed, when reading a register content.

The problem is that conventional circuit techniques reduce the power consumption of a read operation by a limited amount only. Optimizing a scheduling or compiler can actually reduce the number of read operations. This approach, however, is dependent on the underlying architectural dependencies and, therefore, is very specific for a certain microprocessor implementation.

To overcome these problems, forwarding networks are used. These networks store and delay results for a number of cycles. The primary focus of such forwarding networks is to increase performance by supplying any data whenever required. The frequent updates and size, however, adds to power consumption. As a side effect, however, register read operations are reduced at the cost of reading and writing the forwarding network.

### SUMMARY OF THE INVENTION

To increase performance, arithmetic units typically feature a local bypass network, which forwards between different arithmetic units. This avoids the need to wait until a datum is actually written and read from the register file. The present invention uses a local bypass network to avoid register file reads not only for performance reasons, but to save register file read power. As the result, any arithmetic unit can be preserved on its result bus until the next datum is ready. Accordingly, the system of the present invention can avoid a register file read.

In view of the foregoing and other exemplary problems, drawbacks, and disadvantages of the conventional methods and structures, an exemplary feature of the present invention is to provide a method and structure in which results from one or more execution units may be forwarded to other execution units, which have a data dependency to the one more execution units, without having to access a register file.

In a first exemplary, non-limiting aspect of the present invention, a method of reducing latency in instruction processing in a system, the system including a register file, a bypass unit, and a plurality of execution units, wherein at least one of the plurality of execution units depends on data from at least one other of the plurality of execution units, where the method includes calculating a result of a first execution unit of the plurality of execution units, storing the result of the first execution unit of the plurality of execution units in an output latch of the first execution unit, storing the result of the first execution unit in the register file, forwarding the result of the first execution unit, through the bypass unit, to a second execution unit of the plurality of execution units, the second execution unit subsequently conducting a data-dependent instruction dependent on the result of the first execution unit, forwarding the result of the first execution unit, from the bypass unit, to a third execution unit, without accessing the register file, the third execution unit subsequently conducting a data-dependent instruction dependent on the result of the first execution unit, wherein if the first execution unit calculates a new result, the new result is stored in the register file and forwarded to the second execution unit and the third execution unit through the bypass unit, wherein the plurality of execution units can continue to extract the result of the first execution unit through the bypass unit until the new result is calculated, wherein after the new result is calculated, the executions units can access the result of the first execution unit through the register file, and wherein the result is forwarded from directly from the bypass unit to the execution units.

Accordingly, the invention may preserve energy. Power usage is reduced by not having to access the register file to extract data.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a system 100 in accordance with an exemplary embodiment of the present invention;

FIG. 2 illustrates an exemplary waveform diagram illustrating the operation of an execution unit;

FIG. 3 illustrates a method 300 in accordance with an exemplary embodiment of the present invention;

FIG. 4 illustrates and exemplary mapper structure in accordance with the system and method of the present invention; and

FIG. 5 illustrates exemplary phase diagrams of the result register.

### DETAILED DESCRIPTION OF EXEMPLARY EMBODIMENTS OF THE INVENTION

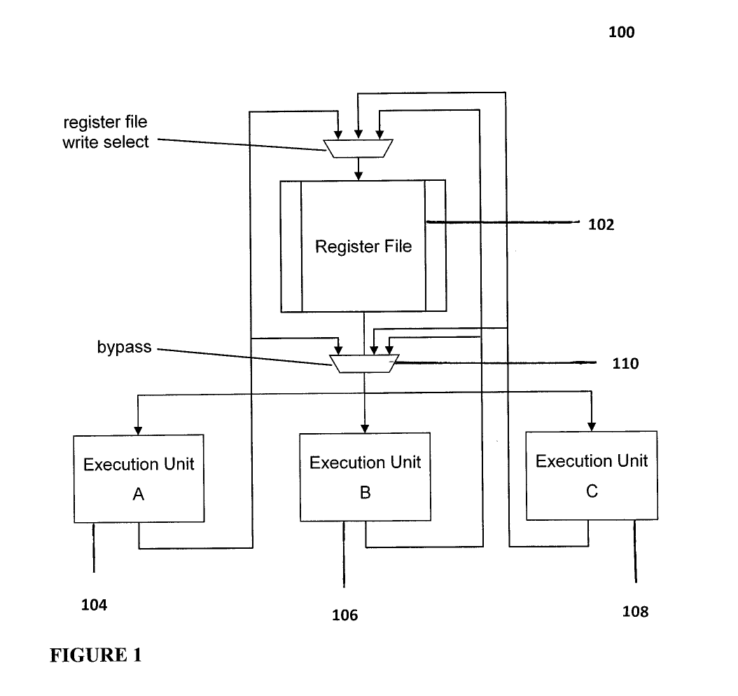

Referring now to the drawings, and more particularly to FIGS. 1-5, there are shown exemplary embodiments of the method and structures according to the present invention.

Forwarding techniques are used to reduce back-to-back latency in pipeline based instruction processing. Results from execution units are forwarded to units having data dependencies (as illustrated in FIG. 1). Typically, bypassing of results is possible only during the time, the result is valid and the dependent instruction is in the data fetch state (e.g., 1 cycle window). After the data fetch state, following instructions can get their data-dependent operands only from the register file via read access.

In certain implementations (e.g., as illustrated in FIG. 1), there are various bypasses or forward networks to hide the latency of writing to and reading from the register file. Such networks can be further exploited to make use of results implicitly stored on the result buses of the individual execution units.

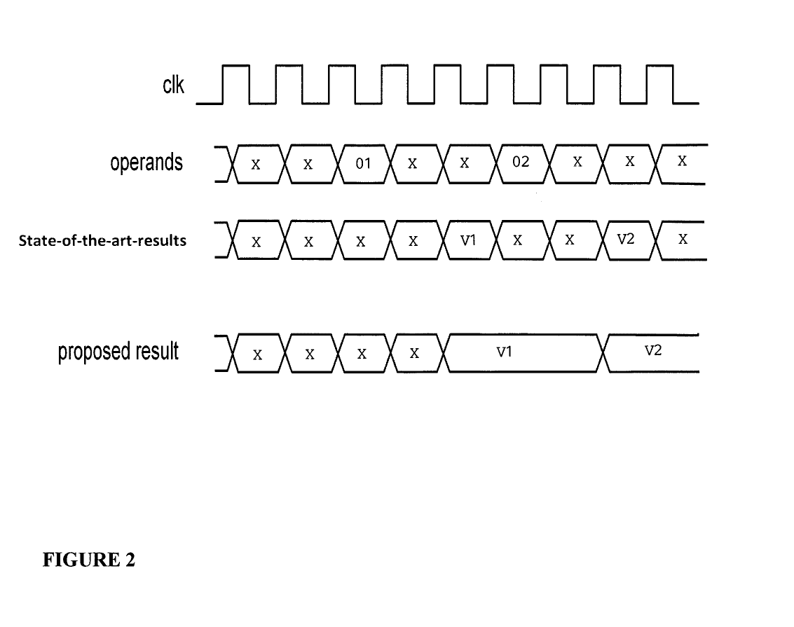

FIG. 2 illustrates a waveform diagram showing exemplary operations of an execution unit. In FIG. 2, two operations are being processed. The operands O1 and O2 are valid for a single cycle only. The execution unit requires a specific number of cycles to process the input operands (the so-called latency). In the example illustrated in FIG. 2, the latency is two cycles. Hence, two cycles after the input operands are valid the results V1 and V2 become valid.

In certain applications, the output signals of the execution units are undefined in any other cycle highlighted with an X in the waveforms above. Executions units, however, could preserve their last result until a new result arrives at the output. This is shown in the lower signal waveform. Such preservation requires a functional hold of the register output value. In a case where clock gating is available, this could be done at almost no additional hardware overhead.

The system according to an exemplary embodiment of the present invention includes three elements. The three elements include (1) a bypass network; (2) a functional hold of results; and (3) extended bypass network control and register file control.

The bypass network sets a feed-forward path in place, such that the result of one execution unit can be directly fed to a second execution unit without the need of first storing the result in the register file and then reading it as register contents of the subsequent operation performed on the second execution unit. The forwarding network does not need to be fully connected. If adequate, a partially connected network might result in smaller overall power consumption.

As a default, the result at the output of an execution unit is only valid in a specific cycle, which is dependent on a moment when an instruction was started and the latency of the unit. During any cycle before and after this specific cycle, the output of an execution unit is typically undefined. As long as the output is undefined, it could also be required to preserve its last valid result until the next result has been processed. Functional clock gating results in this behaviour, assuming that the result latch is only activated if a new result has to be stored.

The extended control of the register file suppresses a register file read operation, if the datum is available in the bypass network. The extended bypass network control detects whether the required register file contents is available in the bypass network. This operation is similar to the operation for the bypass network. The extended control, however, has to take additionally into account that the results are preserved over more cycles.

This approach can additionally be combined with a forwarding network to increase the number of cycle values that can be stored in the forwarding network, and to reduce power in the forwarding network by avoiding writes and read to it.

FIG. 1 illustrates a system 100 (and method) according to certain exemplary embodiments of the present invention. The system 100 includes a register file 102, a plurality of execution units, and a bypass unit 110. In the exemplary system illustrated in FIG. 1, the system 100 includes a first execution unit (execution unit A) 104, a second execution unit (execution unit B) 106, and a third execution unit (execution unit C) 108.

In a typical system, a result of execution unit B 106 is calculated and stored in an output latch of execution unit B 106. The result is then stored in the register file 102 and forwarded, through the bypass unit (bypass multiplexer (MUX)) 110 to another of the plurality of execution units (e.g., execution unit A 104), which executes a data-dependent instruction.

The data in the bypass unit 110 becomes invalid. Thus, the data (i.e., result from execution unit B 106) is only available from the register file 102. Accordingly, while execution A 104 starts its operation, the data dependent operation of execution unit C 108 requires register file read access to extract the data from the register file 102.

Accordingly, in the flow of data handling in the typical system, the execution units must access the register file. Accessing the register file requires a large (undesirable) amount of power.

Referring again to FIG. 1, the system 100 according to present invention reduces the amount of used power.

In accordance with certain exemplary aspects of the present invention, the result of execution unit B 106 is calculated and stored in the output latch of execution unit B 106. The result is then stored in the register file 102 and forwarded, through the bypass unit (bypass multiplexer (MUX)) 110 to another of the plurality of execution units (e.g., execution unit A 104), which executes a data-dependent instruction.

In contrast to the flow of data handling in the typical system (as described above), the bypass unit 110 remains valid. Accordingly, data (e.g., the result of execution unit B 106) is forwarded to execution unit C 108 without a register file read access. The execution units can continue to extract the data from the bypass unit 110 as long as the data is unchanged (e.g., until a new result is calculated). When a new result is calculated, the bypass unit 110 is updated. The original result can still be extracted by accessing the register file 102, while the new result is continually available from the bypass unit 110, without a register file read access.

Accordingly, the present invention does not require the execution units to access the register file and also reduces data switching on the result bus. Accordingly, the system (and method) of the present invention preserves energy.

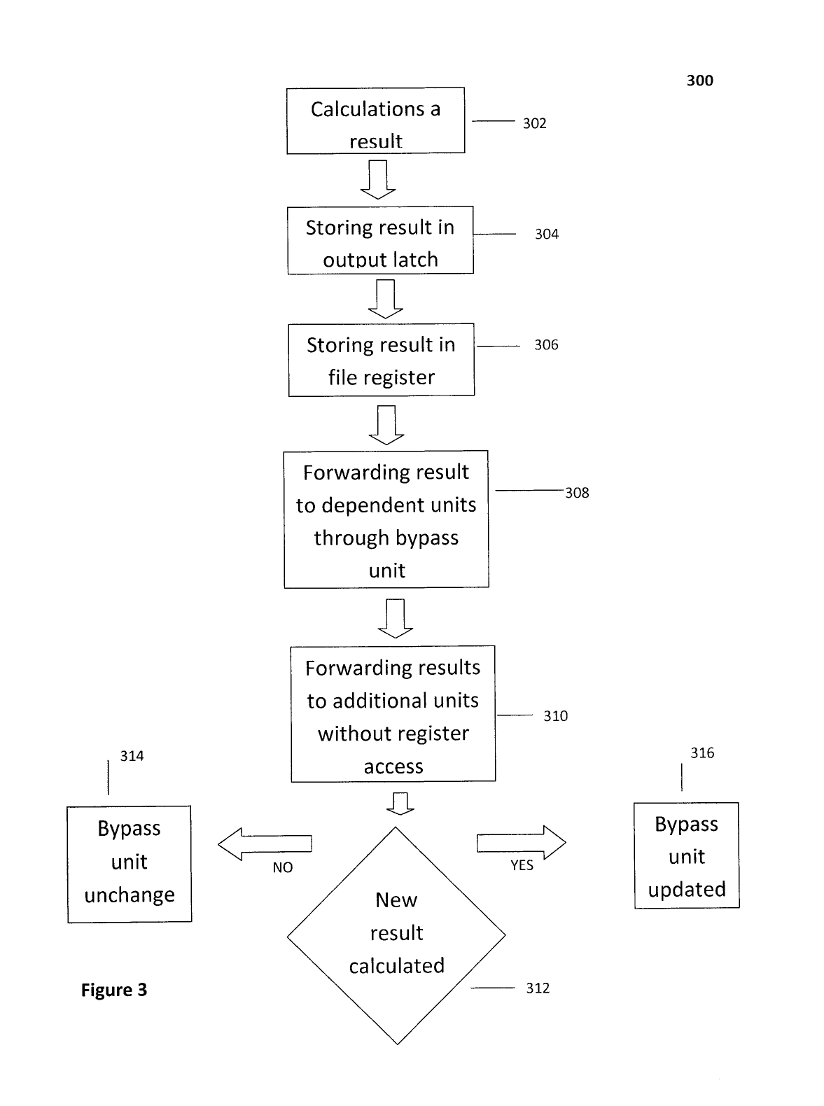

FIG. 3 illustrates a flow diagram of the method described above. The method 300 includes calculating a result of a first execution unit of the plurality of execution units 302, storing the result of the first execution unit of the plurality of execution units in an output latch of the first execution unit 304, storing the result of the first execution unit in the register file 306, forwarding the result of the first execution unit, through the bypass unit, to a second execution unit of the plurality of execution units 308, the second execution unit subsequently conducting a data-dependent instruction dependent on the result of the first execution unit, forwarding the result of the first execution unit, from the bypass unit, to a third execution unit, without accessing the register file 310, the third execution unit subsequently conducting a data-dependent instruction dependent on the result of the first execution unit. If the first execution unit calculates a new result, the new result is stored in the register file and forwarded to the second execution unit and the third execution unit through the bypass unit (312-316). The plurality of execution units can continue to extract the result of the first execution unit through the bypass unit until the new result is calculated, wherein after the new result is calculated, the executions units can access the result of the first execution unit through the file register, and wherein the result is forwarded directly from the bypass unit to the execution units.

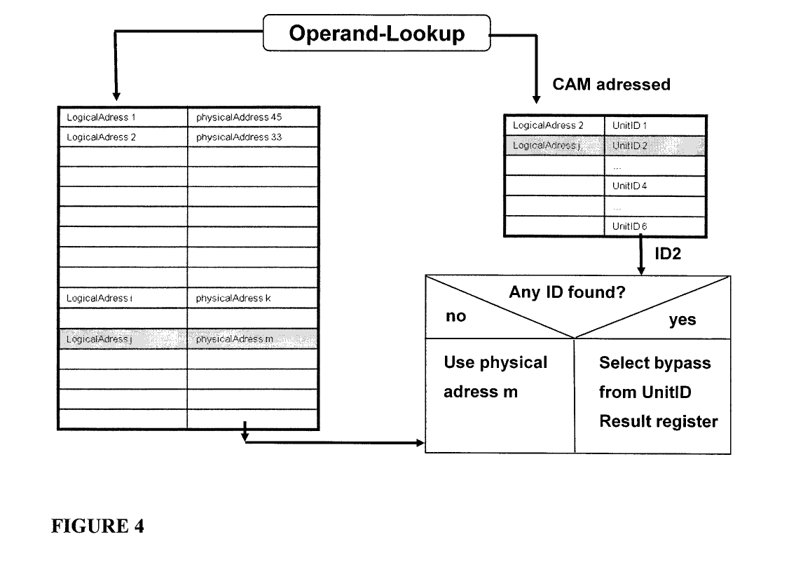

To implement the method of the present invention, the mapper must be equipped with another lookup table (“bypass table” Table 1) and a select mechanism (as illustrated in FIG. 4). The new look table contains two fields per entry, the first contains the logical address, the second contains a pointer to the result register of a functional unit. The result register of the functional unit keeps the result until a new operation on this unit is completed and the result overwritten. This condition can be achieved by clockgating the result latch or by implementing a feedback loop. Advantageously the pointer in the second field is hardcoded, i.e. associated to a certain functional unit.

Initialization of the bypass table is done via reset yielding that the logical addresses are set to invalid addresses. Invalid addresses may be represented by register addresses pointing to a non exiting address space or by means of a valid bit.

If an instruction is executed and completed by a functional unit, then its logical target address is stored in the left field of the corresponding unit in the bypass table.

If a dependent instruction is issued for each source register an operand lookup is started inside the mapper by addressing the alias table of the register renaming and in parallel addressing the bypass table. If the source address is not found in the bypass table the operand data are available from the register file only. Here the register renaming is done via table lookup with the alias table pointing to the physical register which is currently used to keep the architectural state of the source register.

If the bypass table has a hit for the source register the data can be forwarded from the corresponding result register of the functional unit referred to by the unit ID stored in the bypass table.

A hit of the bypass table overrules the register access done via the alias table lookup. Thus, data bypass is preferred to accessing the register file via read access.

There are several implementation schemes possible so that the alias table and the bypass table may be combined to a single table. The basic concept is that the additional information whether and where the data of a (source) register is available from result registers of functional units. This information is available for source logical operands and allows selecting the bypass network appropriately to get the source data to the input operand of dependent instructions without read access of the register file.

For the extension of the multi-cycle register bypass the out-of-order (OoO) mapper is extended with a second auxiliary table which associates the execution result register content with an architectural state. Thus, the result registers can be treated as additional register file entries which can be in several states.

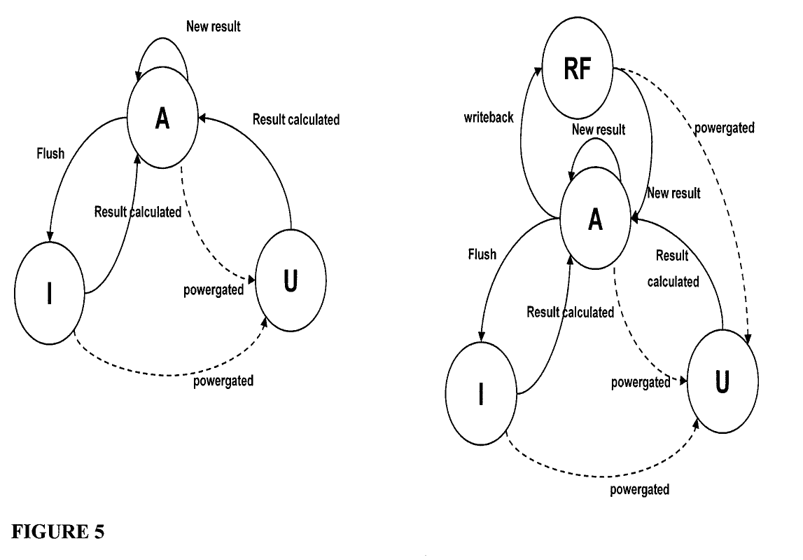

Before any result has been calculated the result registers are in an “un-initialized or unused” (U) state (as illustrated in FIG. 5). If the calculation is completed, then the result is forwarded via the forwarding network and can be used as long as another result is calculated. In both cases, the result register contains a result which can be associated to an architected state (A). Each operation that uses the corresponding architected registers can obtain its source operand from the result register. A flush may “invalidate” (I) the result register, thus all source operands must be obtained via read access from the register file. When an instruction is finished after flush, the register content again represents an architected state. Power gating the logic will cause the result register to the un-initialized state.

When regarding the register file and the update mechanism one can additionally refer to an RF state, which means that the result is stored in the register file and can be obtained from the register file via read access. Thus, the extended phase diagram introduces the register-file (RF) state, which is entered when the write-back of the result into the register file is completed. This usually takes one extra cycle after the result is calculated and available from the result register. If a new result is calculated, then the result register represents the new architected state, whereas the update of the register file is one cycle behind. Thus, the state changes back to A as long as the register file update needs to complete.

These states (U, I, RF, A) determine whether and when the value stored in the result register can be used by forwarding paths to the units source inputs. Therefore, the auxiliary table keeps the states of all result registers available for each execution unit. Each execution unit, and its result register, is identified by a unique unit ID. For each unitID a row is reserved in the auxiliary mapper table (Table 2 in FIG. 4). If the result register is in the architected (A) or register file (RF) state the corresponding architected register address is written into the address field into the corresponding row of the auxiliary mapper table and the valid bit for this entry is set. Upon flushes, all valid bits are reset, powergating or upon powering the unit all valid bits are also reset to zero.

The auxiliary mapper table is accessed via content addressable memory (CAM) addressing. If a new instruction is issued to an execution unit and the source operands are addressed, then the logical address of the source operands are sent as input to the auxiliary mapper table for CAM lookup. Each valid entry in the auxiliary table is compared with the logical address for the operand by using, for example, XOR gates for bitwise address compares. All XOR outputs are ORed (i.e., all input signals/vectors are combined to a single output/vector by performing logical disjunction) together by an (n+1)-input OR with the negated valid bit. If the OR output is “1”, then the corresponding unitID is selected via a MUX and sent as ID2 out of the auxiliary mapper table. The update mechanism reflects the architectural state only one entry will match, if any. The CAM addressing is available for each row of the auxiliary mapper table. All unitID MUXes are cascaded and predefined with all zeros. As unitID “0000 . . . 0” is not associated to any unit one can easily detect whether an execution unit has an architectural state/value in its result register: If the unitID ID2 is unequal to “000 . . . 0”, then a multicycle bypass can be used from the execution unit associated to the unitID ID2. Thus, a register file read accesses can be suppressed.

A typical hardware configuration of an information handling/computer system in accordance with the invention preferably has at least one processor or central processing unit (CPU).

The CPUs are interconnected via a system bus to a random access memory (RAM), read-only memory (ROM), input/output (I/O) adapter (for connecting peripheral devices such as disk units and tape drives to the bus), user interface adapter (for connecting a keyboard, mouse, speaker, microphone, and/or other user interface device to the bus), a communication adapter for connecting an information handling system to a data processing network, the Internet, an Intranet, a personal area network (PAN), etc., and a display adapter for connecting the bus to a display device and/or printer (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable (e.g., computer-readable) instructions. These instructions may reside in various types of signal-bearing (e.g., computer-readable) media.

Thus, this aspect of the present invention is directed to a programmed product, comprising signal-bearing (e.g., computer-readable) media tangibly embodying a program of machine-readable (e.g., computer-readable) instructions executable by a digital data processor incorporating the CPU and hardware above, to perform the method of the invention.

This signal-bearing (e.g., computer-readable) media may include, for example, a RAM contained within the CPU 611, as represented by the fast-access storage for example. Alternatively, the instructions may be contained in another signal-bearing (e.g., computer-readable) media, such as a magnetic data storage diskette, directly or indirectly accessible by the CPU. Whether contained in the diskette, the computer/CPU, or elsewhere, the instructions may be stored on a variety of machine-readable (e.g., computer-readable) data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing (e.g., computer-readable) media. Alternatively, other suitable signal-bearing media may include transmission media such as digital and analog and communication links and wireless.

In an illustrative embodiment of the invention, the machine-readable (e.g., computer-readable) instructions may comprise software object code.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method of reducing latency in instruction processing in a system, the system including a register file, a bypass unit, and a plurality of execution units, wherein at least one of the plurality of execution units depends on data from at least one other of the plurality of execution units, said method comprising:
calculating a result of a first execution unit of the plurality of execution units;
storing the result of the first execution unit of the plurality of execution units in an output latch of the first execution unit;
storing the result of the first execution unit in the register file;
forwarding the result of the first execution unit, through the bypass unit, to a second execution unit of the plurality of execution units, the second execution unit subsequently conducting a data-dependent instruction dependent on the result of the first execution unit; and
forwarding the result of the first execution unit, from the bypass unit, to a third execution unit, without accessing the register file, the third execution unit subsequently conducting a data-dependent instruction dependent on the result of the first execution unit,
wherein if the first execution unit calculates a new result, the new result is stored in the register file and forwarded to the second execution unit and the third execution unit through the bypass unit,
wherein the plurality of execution units can continue to extract the result of the first execution unit through the bypass unit until the new result is calculated,
wherein after the new result is calculated, the execution units can access the result of the first execution unit through the register file, and
wherein the result is forwarded directly from the bypass unit to the execution units.
